(19) United States
(12) Patent Application Publication
(10) Pub. No.: US 2010/0171274 A1
(43) Pub. Date: Jul. 8, 2010

(54) GASKET RING

(75) Inventor: Emmy Öhlund, Goteborg (SE)

Correspondence Address: WRB-IP LLP, 801 N. Pitt Street, Suite 123, ALEXANDRIA, VA, 22314, US

(73) Assignee: VOLVO LASTVAGNAR AB, Göteborg (SE)

(21) Appl. No.: 12/516,386

(22) PCT Filed: Nov. 27, 2006
(86) PCT No.: PCT/SE06/01337

§ 371 Date: Dec. 28, 2009

(51) Int. Cl. F02F 11/00; F16J 15/06

(52) U.S. Cl. 277/591; 277/637

(57) ABSTRACT

The invention relates to a metal gasket ring (16) comprising an annular holder part (16a) and an annular resilient part (16b). The holder part (16a) forms a support surface for the resilient part (16b). A peripheral edge section (17) of the holder part (16a) is bent so that it overlaps the outer edge of the resilient part. The resilient part (16b) is provided with a bead (20), which projects outwards beyond the edge section (17) of the holder part, radially inside said edge section (17).

### TECHNICAL FIELD

The present invention relates to a metal gasket ring, comprising an annular holder part and an annular resilient part.

### BACKGROUND OF THE INVENTION

Sealing problems can occur in the case of assemblies subject to high gas pressures and temperature fluctuations. Such is the case when fixing injectors into the cylinder head of a diesel engine. An injector is usually fitted into a space in the cylinder head cooled by coolant by means of a copper sleeve, which is flanged at the bottom and sealed at the top by an O-ring. A screw connection presses the spray part against the flanged section of the sleeve, which is usually provided with a deformable bead for achieving the requisite sealing up against the cylinder head wall. Gas leakage can nevertheless occur at the contact face between the end of the injector and the flanged section of the sleeve. A leak often occurs after replacing the injector. One cause of this problem may be that the inlet side of the cylinder head is cooler than the exhaust side, so that the flange section bead becomes unevenly deformed. If leakage occurs, this can lead to resulting problems occurring, with damage to the cylinder head and costly operating interruptions.

The leakage problem described above can be avoided by changing the copper sleeve at the same time as the injector. This means, however, that the coolant has to be drained off from the cylinder head, which together with the material cost of the sleeve entails substantially increased costs for this servicing operation.

It would be desirable to be able to change injectors in an engine without the risk of leakage and without changing the copper sleeve.

### SUMMARY OF THE INVENTION

An object of the invention is therefore to produce a gasket ring which will withstand an environment with large temperature fluctuations and uneven pressure load, and which will allow injectors in an engine to be changed without the risk of leakage and without changing the copper sleeve.

According to the invention a metal gasket ring for this purpose comprises an annular holder part and an annular resilient part and is characterized in that the holder part forms a support surface for the resilient part, that a peripheral edge section of the holder part is bent so that it overlaps the outer edge of the resilient part, and that the resilient part is provided with a bead, which projects outwards beyond the edge section of the holder part, radially inside said edge section. This embodiment of the gasket ring according to the invention makes it possible to produce a resilient sealing joint between the injector and the copper sleeve, which will withstand an uneven pressure load and large temperature fluctuations.

In one exemplary embodiment of the invention the holder part may be made from a material that is easier to form than the material from which the resilient part is manufactured. This facilitates forming of the composite gasket ring.

In another exemplary embodiment of the invention the holder part may be provided with a number of indentations along the outer edge. The indentations make it easier to bend the edge of the holder part around the edge of the resilient part when forming the composite gasket ring.

In a further exemplary embodiment of the invention the holder part may be provided with a number of tongues oriented radially inwards towards the center of a central opening. This is a simple way of providing means for fixing the gasket ring around the injector spray tip, which makes it easier to fit the injector with gasket ring in the injector sleeve.

According to an advantageous variant of the invention the gasket ring in its position of use is fitted in a cylinder head, as seal between an injector and an injector sleeve.

### BRIEF DESCRIPTION OF THE DRAWINGS

The invention will be described in more detail below with reference to exemplary embodiments, which are shown in the drawings attached, in which

FIG. 1 in a schematic sectional side view shows a cylinder head with injector and a gasket ring according to the invention,

FIG. 2 shows the gasket ring in plan view on a larger scale, and

FIG. 3 is a section along the line in FIG. 2.

### DESCRIPTION OF EXEMPLARY EMBODIMENTS

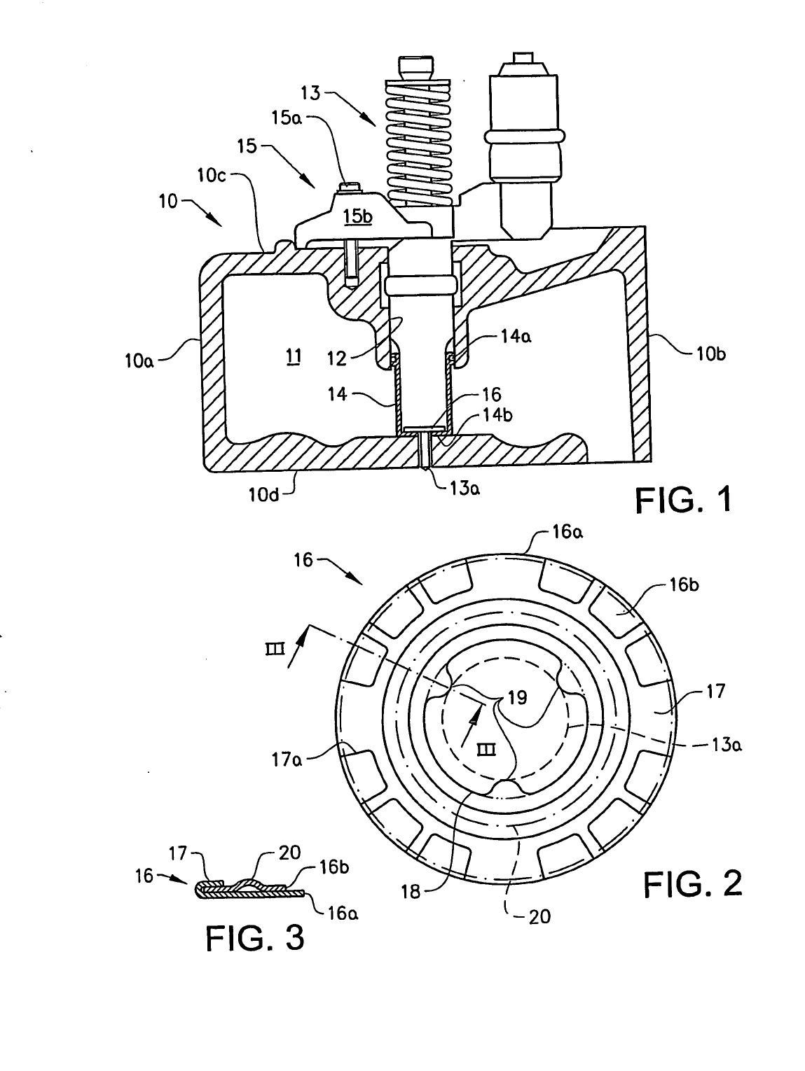

The cylinder head 10, shown in FIG. 1, forming part of a diesel engine, is provided with side walls 10a and 10b, outer wall 10c and cylinder head wall 10d, which together define an internal cavity 11 for coolant. The outer wall 10c is provided with a cylindrical bushing for an injector 13, which with its spray tip 13a projects via a passage through the cylinder head wall 10d into the combustion chamber (not shown). An injector sleeve 14 extends between the outer wall 10c and the inside of the cylinder head wall 10d, and is provided with an O-ring seal 14a inside the bushing 12 and a flanged section 14b at the contact face with the cylinder head wall 10d. The injector 13 is fitted by means of a clamped union 15 comprising a bolt 15a and a clamping shoe 15b, in such a way that the injector presses with a predefined force against the cylinder head wall 10d. A gasket ring 16 is arranged between a shoulder section 13b of the injector and the flanged section 14b of the sleeve 14.

The gasket ring 16 is shown in plan view on a larger scale in FIG. 2 and is made of metal, comprising an annular holder part 16a and an annular resilient part 16b. The function of the holder part 16a is to form a support surface for and to center the resilient part 16b. For this purpose a peripheral edge section 17 of the holder part 16a is bent around the outer edge of the resilient part 16b, so that the edge section partially overlaps the latter. In addition, the holder part 16a is provided with a number of tongues 19, which are oriented radially inwards towards the center of a central opening 18 and which are designed to grip around the spray tip 13a and to center the holder part in relation thereto. A further function of the tongues 19 is to hold the gasket ring 16 fast around the spray tip during fitting, which makes it easier to fit the injector with gasket ring in the injector sleeve.

The resilient part 16b is provided with an annular bead 20 radially inside the edge section 17 of the holder part, the bead 20 being dimensioned so that it projects outwards at right angles from the plane of the gasket ring 16 beyond the edge section of the holder part.

Because the gasket ring 16 comprises two separate parts, metal of different characteristics can be used in these parts. Thus, for the holder part 16a it is possible to use a material that is easier to form than the material from which the resilient part 16b is manufactured. At the same time a material having elastic characteristics can be used for the resilient part 16b. A number of indentations 17a in the edge section 17 of the holder part are designed to make it easier to bend the edge of the holder part around the edge of the resilient part when forming the composite gasket ring.

Because the edge section 17 of the holder part 16a prevents compression of the bead, the latter can retain its elastic characteristics within a favorable interval, even though the bead is pressed down so far that the shoulder section of the injector rests against the edge section 17. This means that the seal will be maintained even if the pressure load is uneven.

The invention must not be regarded as being limited to the exemplary embodiments described above, a number of further variants and modifications being feasible without departing from the scope of the following patent claims. For example, the indentations 17a of the edge section 17 are not essential to the functioning of the gasket ring. The resilient part may furthermore be provided with more than one annular bead.

1. A metal gasket ring comprising an annular holder part and an annular resilient part, wherein the holder part forms a support surface for the resilient part, that a peripheral edge section of the holder part is bent so that it overlaps the outer edge of the resilient part, and that the resilient part is provided with a bead, which projects outwards beyond the edge section of the holder part, radially inside the edge section.

2. The gasket ring as claimed in claim 1, wherein the holder part is made from a material that is easier to form than the material from which the resilient part is manufactured.

3. The gasket ring as claimed in claim 1, wherein the holder part is provided with a number of indentations along the outer edge of the edge section.

4. The gasket ring as claimed in claim 1, wherein the holder part is provided with a number of tongues oriented radially inwards towards the center of a central opening.

5. The gasket ring as claimed in claim 1, wherein in its position of use it is fitted in a cylinder head, as seal between an injector and an injector sleeve.

6. The gasket ring as claimed in claim 2, wherein the holder part is provided with a number of indentations along the outer edge of the edge section.

7. The gasket ring as claimed in claim 2, wherein the holder part is provided with a number of tongues oriented radially inwards towards the center of a central opening.

8. The gasket ring as claimed in claim 2, wherein in its position of use it is fitted in a cylinder head, as seal between an injector and an injector sleeve.

9. The gasket ring as claimed in claim 3, wherein the holder part is provided with a number of tongues oriented radially inwards towards the center of a central opening.

10. The gasket ring as claimed in claim 3, wherein in its position of use it is fitted in a cylinder head, as seal between an injector and an injector sleeve.

11. The gasket ring as claimed in claim 4, wherein in its position of use it is fitted in a cylinder head, as seal between an injector and an injector sleeve.
